(19) United States
(12) Patent Application Publication
(10) Pub. No.: US 2020/0032987 A1
(43) Pub. Date: Jan. 30, 2020

(54) LIGHT FIXTURE

(71) Applicant: Beta-Calco Inc, Toronto (CA)

(72) Inventors: Patrick Stark, Toronto (CA); Remy Silver, Toronto (CA)

(21) Appl. No.: 16/046,249

(22) Filed: Jul. 26, 2018

(51) Int. Cl. F21V 21/04; F21V 21/14; F21V 21/088; F21S 8/02; F21V 19/02

(52) U.S. Cl. CPC F21V 21/044; F21V 21/14; F21V 19/02; F21S 8/026; F21V 21/088

(57) ABSTRACT

The present invention relates to a light fixture, comprising: a housing, the housing dimensioned to contain one or more lights, and the housing comprising a pair of parallel spaced rails operative to support the lights; and one or more lights, each light comprising a light bulb, a first rotatable gimbal mount removably coupled to the light bulb, a second gimbal mount coupled to the first gimbal mount such the axis of rotation of the second gimbal mount is perpendicular to the axis of rotation of the first gimbal mount, and a first clip and a second clip coupled to the second gimbal mount, the first clip and second clip oriented parallel to each other, and the first clip and second clip operative to engage the rails in the housing without tools, wherein the light is capable being positioned and repositioned within the housing via rotation around the two axes of rotation of the first and the second gimbal mounts.

### FIELD OF THE INVENTION

The present specification relates generally to a light fixture, and, in particular, to a light fixture with gimbal clips that enable lights to be removably secured without tools via the gimbal while permitting movement of the gimbal along an axis of rotation.

### BACKGROUND OF THE INVENTION

Recessed and track light fixtures often see use in both commercial and residential applications as fixtures which permit one or more of the lights within the fixture to be positionally adjusted post-installation. Particularly in residential applications, exposed tracks and other components are perceived as undesirable from an aesthetic perspective. A solution is to provide an enclosed or recessed fixture which conceals some or all of the components. However, a recessed fixture results in further limitations on positional adjustment of the lights, particularly where the lights are secured either permanently, or in a manner which requires tools (screwdriver, wrench) for removal and/or adjustment. Thus, the available positional adjustments to the lights within the fixture may be limited as a consequence of aesthetic design of the fixture and housing.

Therefore, it would be desirable to have a light fixture which provides an aesthetically appealing design while mitigating some of the disadvantages currently known in the art.

Accordingly, there remains a need for improvements in the art.

### SUMMARY OF THE INVENTION

In accordance with an aspect of the invention, there is provided a light and light fixture and, in particular, a light fixture comprising gimbal clips that enable lights to be removably secured via the gimbal without tools while permitting movement of the gimbal along an axis of rotation.

According to an embodiment of the invention, there is provided a light fixture, comprising: a housing, the housing dimensioned to contain one or more lights, and the housing comprising a pair of parallel spaced rails operative to support the lights; and one or more lights, each light comprising a light bulb, a first rotatable gimbal mount removably coupled to the light bulb, a second gimbal mount coupled to the first gimbal mount such the axis of rotation of the second gimbal mount is perpendicular to the axis of rotation of the first gimbal mount, and a first clip and a second clip coupled to the second gimbal mount, the first clip and second clip oriented parallel to each other, and the first clip and second clip operative to engage the rails in the housing, wherein the light is capable being positioned and repositioned within the housing via rotation around the two axes of rotation of the first and the second gimbal mounts.

According to a further embodiment of the invention, there is provided a light for use within a light fixture, comprising: a light bulb, a first rotatable gimbal mount removably coupled to the light bulb, a second gimbal mount coupled to the first gimbal mount such the axis of rotation of the second gimbal mount is perpendicular to the axis of rotation of the first gimbal mount, and a first clip and a second clip coupled to the second gimbal mount, the first clip and second clip oriented parallel to each other, and the first clip and second clip operative to engage a pair of rails in the light fixture, wherein the light is capable being positioned and repositioned within the light fixture via rotation around the two axes of rotation of the first and the second gimbal mounts.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a bottom perspective view of a light fixture according to an embodiment;

FIG. 2 is a side view of the light fixture of FIG. 1 with the interior exposed;

FIG. 3 is a side view of a light according to an embodiment;

FIG. 4 is a bottom perspective view of the light of FIG. 3;

FIG. 5 is a top perspective view of the light of FIG. 3;

FIG. 6 is an end view of a light within the light fixture of FIG. 1 in a pre-installation position; and

FIG. 7 is an end view of the light of FIG. 6 in an installed position.

Like reference numerals indicated like or corresponding elements in the drawings.

### DETAILED DESCRIPTION OF THE EMBODIMENTS

The present invention relates to lights and light fixtures and, in particular, to a light fixture comprising gimbal clips that enable lights to be removably secured via the gimbal while permitting movement of the gimbal along an axis of rotation.

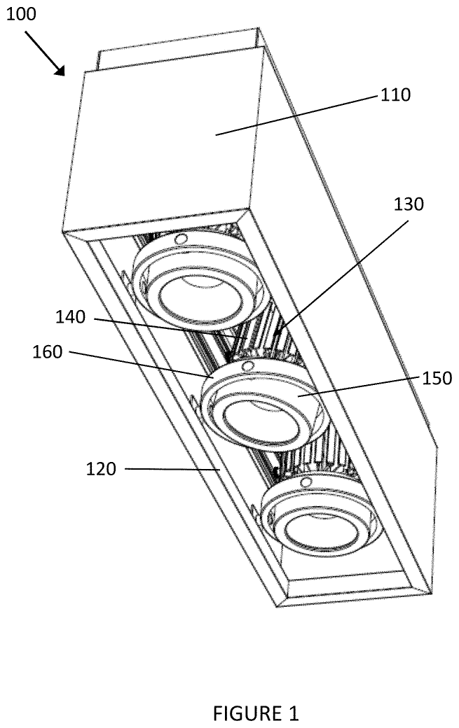

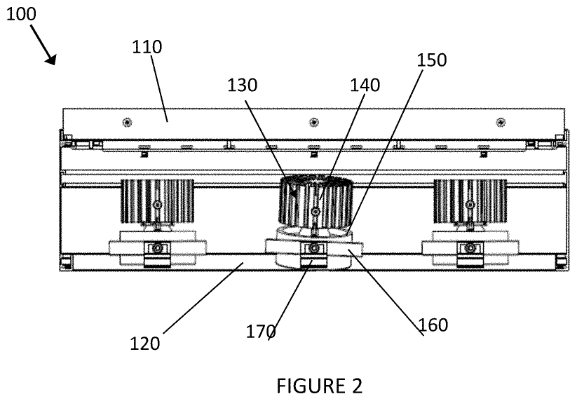

According to an embodiment as shown in FIGS. 1 and 2, a light fixture 100 may include a housing 110 which is provided with pair of parallel rails 120 for mounting one or more lights 130. Each light 130 may consist of a light bulb 140 which is removably coupled to a first gimbal mount 150. The first gimbal mount 150 permits the light bulb 140 to be positioned and repositioned by rotating the first gimbal mount 150 along an axis of rotation. As shown, the axis of rotation of the first gimbal mount 150 is parallel to the rails 120. The light fixture 100 may be recessed into a ceiling, surface mounted to a ceiling, or suspended beneath a ceiling, depending on the physical space requires and the user's desired aesthetic presentation.

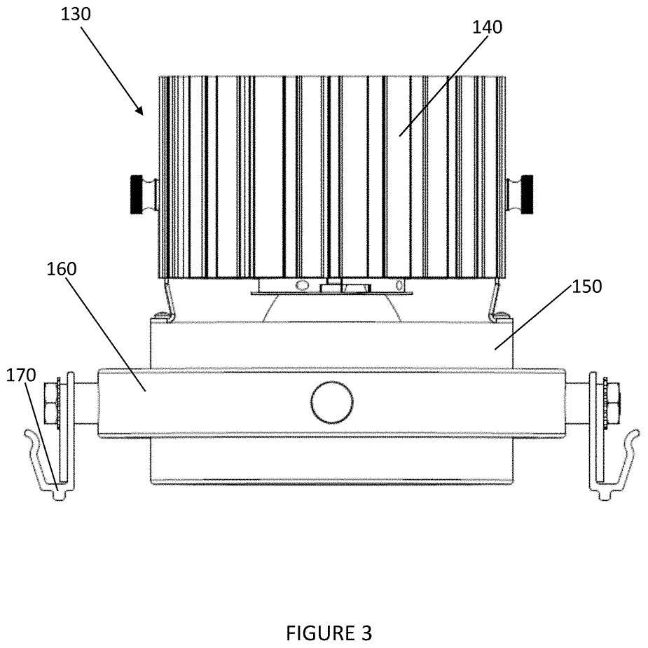

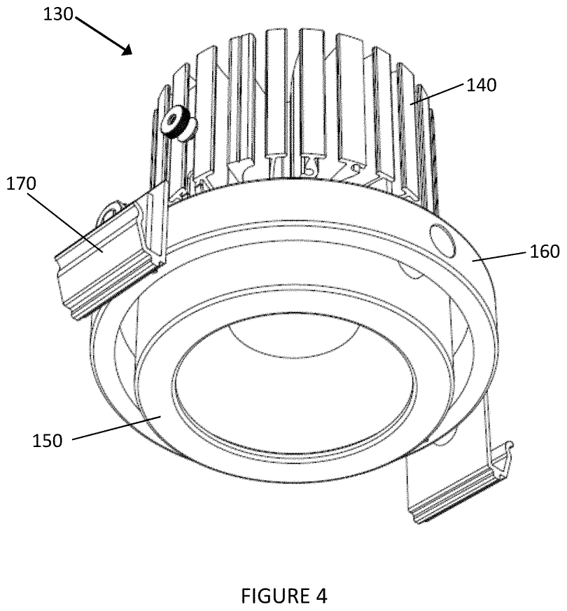

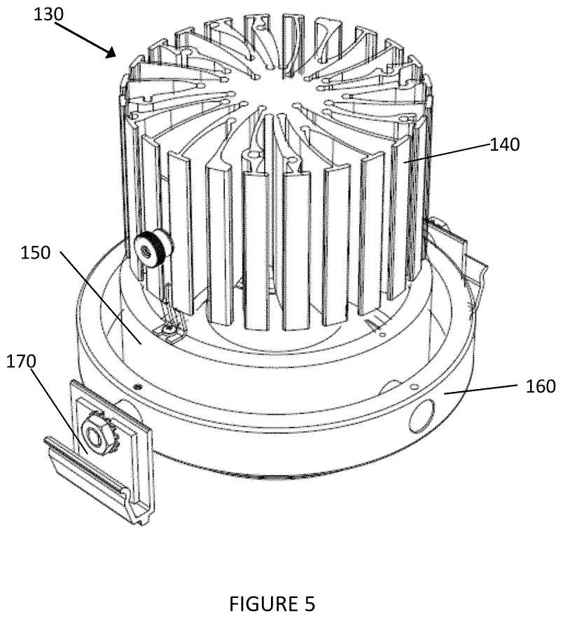

As shown in the isolation views of the light 130 in FIGS. 3, 4, and 5, the first gimbal mount 150 may be further coupled to a second gimbal mount 160. The second gimbal mount 160 has an axis of rotation which is perpendicular to the axis of rotation of the first gimbal mount 150. Thus, the light bulb 140 is provided with positional adjustment via the two axes of rotation of the gimbal mounts 150, 160 once installed within the housing 110.

The second gimbal mount 160 further includes a pair of clips 170 which are coupled to the second gimbal mount 160 and oriented substantially parallel to each other. The clips 170 engage the rails 120 to removably secure the light 130 within the housing 110. Additionally, the clips 170 permit the light 130 to be repositioned once installed via linear movement of the clips 170 along the rails 120. Thus, each installed light 130 is provided with an adjustment via the two axes of rotation as well as linearly along the rails 120 once installed within the housing 110.

As shown, gimbal mounts 150, 160 are circular, however, other shapes, such as square, oval and rectangular may be used, depending on the structure of the housing and light bulb, as well as any desired aesthetic considerations.

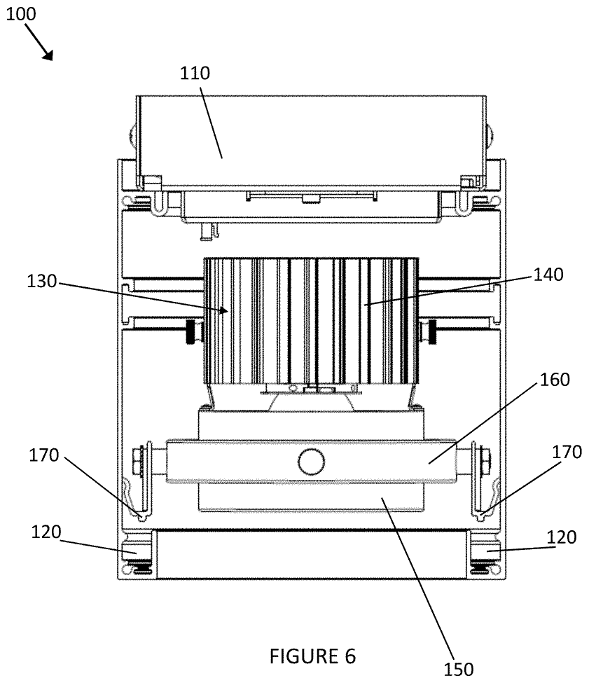

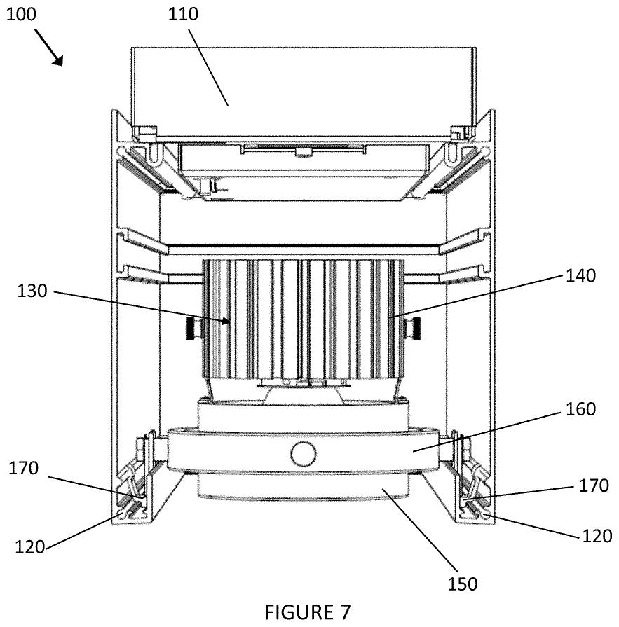

Referring to FIGS. 6 and 7, each light 130 may be installed within the housing 110 by first inserting the light 130 into the housing 110 with the clips 170 above the rails 120, as shown in FIG. 6. The light 130 may then be lowered such that clips 170 compress and engage with the rails 120 as shown in FIG. 7 (also shown in FIG. 2). This operation is performed without tools, using hand force only. The clips 170 are preferably spring clips formed from an extruded polymer material such that when the clips 170 are engaged with the rails 120 a slight tension is created which secures the light 130 to the rails 120 while still permitting movement the light 130 to be repositioned or removed once installed, again by hand force only and without tools. Additionally, clips 170 provide a strictly mechanical connection, the electrical connection to the light 130 and light bulb 140 is provided though other means (not shown).

Clips 170 should be compressible via installation as described above by hand force, to permit installation, repositioning and removal without tools. To install light 130, it may be rotated such that the clips 170 are aligned away from the rails 120, such that second gimbal 160 fits within the space provided in the housing 110 between the rails. Alternatively, depending on the shape of the gimbal 160 and size of the light 130, it may be tilted or pivotal instead. After insertion into the housing 110, the light may be rotated or otherwise repositioned such that the clips 170 are aligned with and over the rails 120. The light may then be lowered into position (see FIG. 7), with slight pressure provided to compress the clips 170 to fit within and engage the rails 120. Once engaged, the light 130 may be moved along the rails 120 to a desired position, if necessary. Similarly, first gimbal 150 and second gimbal 160 may be rotated as well to position light 130 as desired. This process may then be repeated as many times as required to insert all lights within the housing.

Alternatively, the light fixture 100 may be provided with lights 130 pre-installed and the user may reposition the lights 130 as desired via movement along the rails 120 and rotation of the gimbals 150, 160.

As shown, the housing 110 contains three lights 130. However, it may be understood that the housing 110 may contain any number of lights 130, from as few as one to as many as physical space and electrical connections may permit.

The specifics of the electrical connection to the light bulbs has been omitted herein as the nature of the connection is dependent upon the design of the housing and the nature of the light bulbs. It is expected that those skilled in the art will make the required electrical connections in accordance with these dependencies and based upon their own skill.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A light fixture, comprising:
a housing, the housing dimensioned to contain one or more lights, and the housing comprising a pair of parallel spaced rails operative to support the lights; and
one or more lights, each light comprising a light bulb, a first rotatable gimbal mount removably coupled to the light bulb, a second gimbal mount coupled to the first gimbal mount such the axis of rotation of the second gimbal mount is perpendicular to the axis of rotation of the first gimbal mount, and a first clip and a second clip coupled to the second gimbal mount, the first clip and second clip oriented parallel to each other, and the first clip and second clip operative to engage the rails in the housing,
wherein the light is capable being positioned and repositioned within the housing via rotation around the two axes of rotation of the first and the second gimbal mounts.

2. The light fixture of claim 1, wherein the first clip and the second clip are formed as compressible spring clips from an extruded polymer.

3. The light fixture of claim 2, wherein the first clip and the second clip are engaged to the rails without tools.

4. The light fixture of claim 1, wherein the first clip and the second clip are not in electrical connection with the rails.

5. The light fixture of claim 1, wherein the housing is one of: recessed into a ceiling;
secured to a ceiling; and suspended from a ceiling.

6. The light fixture of claim 1, wherein the axis of rotation of the first gimbal mount is parallel to the rails.

7. The light fixture of claim 1, wherein the first gimbal mount and the second gimbal mount are circular.

8. The light fixture of claim 1, wherein the light is further capable of linear movement along the rails once engaged via movement of the clips.

9. A light for use within a light fixture, comprising:
a light bulb, a first rotatable gimbal mount removably coupled to the light bulb, a second gimbal mount coupled to the first gimbal mount such the axis of rotation of the second gimbal mount is perpendicular to the axis of rotation of the first gimbal mount, and a first clip and a second clip coupled to the second gimbal mount, the first clip and second clip oriented parallel to each other, and the first clip and second clip operative to engage a pair of rails in the light fixture,
wherein the light is capable being positioned and repositioned within the light fixture via rotation around the two axes of rotation of the first and the second gimbal mounts.

10. The light of claim 9, wherein the first clip and the second clip are formed as compressible spring clips from an extruded polymer

11. The light of claim 10, wherein the first clip and the second clip are engaged to the rails without tools.

12. The light of claim 9, wherein the first clip and the second clip are not in electrical connection with the rails.

13. The light of claim 9, wherein the axis of rotation of the first gimbal mount is parallel to the rails.

14. The light of claim 9, wherein the first gimbal mount and the second gimbal mount are circular.

15. The light of claim 9, wherein the light is further capable of linear movement along the rails once engaged via movement of the clips.
